(19) United States
(12) Patent Application Publication
(10) Pub. No.: US 2008/0163661 A1
(43) Pub. Date: Jul. 10, 2008

(54) Dent Removing Method and Device

(76) Inventors: Ralph Meichtry, Richterswil (CH); Ivan Kouba, Prague (CZ)

Correspondence Address: OSTROLENK FABER GERB & SOFFEN, 1180 AVENUE OF THE AMERICAS, NEW YORK, NY, 100368403, US

(21) Appl. No.: 11/910,788

(22) PCT Filed: May 11, 2006
(86) PCT No.: PCT/CH2006/000254

§ 371 Date: Dec. 18, 2007

Related U.S. Application Data
(60) Provisional application No. 60/680,303, filed on May 12, 2005.

(51) Int. Cl. B21D 1/06; B21D 1/00; B21D 26/14; B21D 26/00; B64F 5/00

(52) U.S. Cl. 72/56

(57) ABSTRACT

The present application relates to a method and a device for removing dents in a sheet metal structure based on electromagnetic energy. A device in accordance with an embodiment of the present application includes a working head which is interconnected to a power device by a connecting cable.

### FIELD OF THE INVENTION

The herein discussed invention is directed to an electromagnetic dent removing method for removing dents in a sheet metal structure and a device for carrying out the method.

### BACKGROUND OF THE INVENTION AND PRIOR ART

From prior art electromagnetic dent removers are known which are suitable to remove dents in sheet metal structures, especially sheet metal structures made out of non-ferromagnetic materials, e.g. of air planes.

U.S. Pat. No. 4,986,102, Hendrickson et al. (the Boeing Company, 1991), describes an electromagnetic dent remover having a tapped work coil. A first current pulse is applied to an inner and an outer coil to produce an electromagnetic field that exerts a repelling force on a conductive part. A second current pulse having an opposite polarity to the first current pulse and a rise time shorter than that of the first pulse, is applied to the inner coil which collapses the electromagnetic field associated with the inner coil and causes a pulling force to be exerted on a part by the inner coil. The work coil is positioned over a dent in the conductive part so that the pulling force produced by the inner coil is concentrated on the dent and pulls the dent from the part. Simultaneously, the pulling force is counteracted by the repelling force produced with the outer coil. The repelling force stabilizes the part to facilitate the removal of the dent. In addition, to stabilize the part the repelling force created by the outer coil may be used to remove convex deformations of the dent.

U.S. Pat. No. 4,061,007, respectively U.S. Pat. No. 4,127,933, Hansen et al. (the Boeing Company 1977), describes an electromagnetic dent remover including a dent removal head with an electromagnetic work coil which is capable of creating a locally concentrated magnetic field when first energized by a slow rising current followed by a fast pulsing counter current. The electromagnetic work coil comprises a cylinder formed of a spirally wound metal strip whose convolutions are electrically insulated from one another by coating layers of electrical insulation. In one form, slots and holes, located in the walls of the coil, control the electrical current density within the coil to thereby produce the desired locally concentrated magnetic field. In another form, the ends of the coil are machined such that at least one magnetic field concentration projection projects outwardly from one annular end of the coil. The other end of the coil is machined such that it is the mirror image of the projection end. In either form the electromagnetic work coil is encased in a nonmagnetic housing which may be formed by encapsulation.

U.S. Pat. No. 3,998,081, Hansen et al. (the Boeing Company, 1976) describes an apparatus and a method for electromagnetically removing dents from a conductive, non-ferromagnetic material. A coil serves to direct an effective electromagnetic coupling to a limited area between the coil and a dented part. The coil is first energized with a slowly rising current then is energized with a fast pulsing counter current to generate a pulling force.

U.S. Pat. No. 5,046,345, Zieve et al. (1991), describes a power supply for use with an electromagnetic dent removal system or proof load testing. The power supply includes slow and fast current pulse system. The slow current pulse system includes a capacitor bank which is charged up to 1000 volts, while the fast current pulse system includes a capacitor bank which is charged up to 10k volts. Control switches are provided for each system which result in discharge of the respective capacitor banks into a work coil adjacent to the workpiece at selected times. A crowbar circuit is provided across the coil, and is triggered following discharge of the fast current pulse system. The crowbar circuit includes a series connection of several diodes to block the high negative reverse voltage and a device to block the low forward voltage. An anti-parallel diode is connected to prevent possible damage by the rapid sequence of the reverse voltage.

All the above mentioned systems of Boeing are using a relatively long spiral coil with concentrating means, such as cut-outs and protrusions, for concentration of magnetic fields. The axis of symmetry, which is the symmetry axis of attracting forces for removing dents, is parallel with the coil axis and passes through the area of a coil field concentrator, whereby the axis of the coil is in general offset with respect to the attracting forces. The method comprises two working cycles whereby in a first stage, a relatively slow initial preparation phase, magnetic energy is accumulated inside the coil of the working tool. A small gradient of changes in the magnetic field in this initial phase mineralizes repulsive Lorentz-Forces between working tool and the sheet metal to be treated. In a second, substantially faster phase, the magnetic field is decreasing significantly more rapid such that there are attracting forces occurring in the area of the concentrator between the coil working tool and the sheet metal.

### SUMMARY OF THE INVENTION

The herein discussed invention is directed to an improved method and device for repairing/removing of dents, e.g. dents as they occur due to hail storm damage or park damage, in a surface of a sheet metal structure made out of ferromagnetic sheet metal.

For removing a dent in a ferromagnetic sheet material in a preferred embodiment a working coil is arranged above the damaged area in general on the concave side of the dent. The working coil is incorporated in a working head which in general comprises a housing and a cooling system e.g. with a circulating cooling fluid for cooling the working coil during operation. Alternatively or in addition other cooling systems may be appropriate. Tests have been conducted with cooling systems which base on the Peltier Effect.

The housing further comprises supporting means to directly or indirectly position the working head above the area to be repaired and/or to carry off reaction forces into the surrounding sheet metal structure during operation of the device. The housing of the working head is preferably made such that it protects, supports and stabilizes the working coil with respect to internal and external forces and reactions. Furthermore the working head may comprise control means such as sensors which measure parameters that are important for the procedure, such as force, temperature, current and/or voltage. The working head is driven by a power device which is interconnected to the working head by appropriate electric connectors. The power device in general comprises charging means, reservoir means, switching means and control means. In a preferred embodiment a switching power supply serves as a charging means for an array of capacitors which are serving as a reservoir means. The capacitors are interconnected with a working head via at least one switching means, e.g. in the form of a thyristor, and a connecting cable. If appropriate a control means serves to trigger and control the release of the electrical energy stored in the capacitors into a working coil arranged in a working head. The same or another control means may also serve to control and trigger the charging process of the reservoir means and/or the dent removal process.

The method for removing dents according to the present invention can be summarized briefly as follows. In a first step the reservoir means is filled up with electrical energy by the charging device. The working coil, respectively the working head, is arranged on the concave side of a dent in a sheet metal structure to be repaired in general concentrically to the centre of the dent. Then at least a part of the electrical energy stored in the reservoir means is released in a controlled manner as a pulse or a series of pulses into the working coil by making the switching means conductive. Thereby a magnetic field is actuated in the working coil implementing the mechanical force for reducing the depth of the dent at least partially. If necessary the steps of the process are repeated.

In an embodiment the dent removal device comprises feed back means which control the amount of electrical energy released into the working coil with respect to the shape/depth of the dent to be removed. E.g. by an optical sensor the shape of the dent is captured and used as an input/feed back signal in a processing unit for controlling the process of dent removing.

A method according to the present invention takes into account that ferromagnetic steel is a relatively good electric conductor. For providing a mechanical force Fₘ which has an effect on a ferromagnetic conductor located in a magnetic field the following formula applies in general: Fₘ=[J×B]−0.5H²grad(μ) (equation 1) whereby the first part of the equation [J×B] describes the Lorentz-Force (Force per length) in function of a current J acting on a conductor arranged within the magnetic field B. The second part of the equation describes the force due to a magnetic field H which acts in an interface area of two substances with different permeability μ. A preferred method of the herein described invention primarily relates to the second part 0.5H²grad(μ) of the above-mentioned equation while the influence of the first part [J×B] of the equation is of lower significance.

For the efficiency of the system with regard to the mechanical force and its concentration occurring in the interface area of two substances with different permeability, here in general air/sheet metal/air, the magnetic field H is preferably arranged perpendicular to the interface area. This condition can be achieved by using a strong quasi stationary magnetic field. The impulse of a very strong magnetic field, in which the ferromagnetic sheet metal involved is strongly oversaturated results in the herein preferred high and precisely locatable forces based on the second part of equation 1. The Lorentz-Forces between the coil of the working tool and the sheet metal are thereby in this embodiment of minor relevance. Alternatively or in addition the Lorentz-Force may be of major significance. This may be achieved by a different coil design.

The frequency spectrum of an impulse is limited by the following formula

$${f}_{max} [ Hz ] ≪ \frac{1}{{πμ}_{0} σ {d}^{2}} \qquad ( equation 2 )$$

wherein μ₀ is the permeability of vacuum (air), σ is the electric conductivity of the sheet metal and d is the thickness of the sheet metal to be repaired. In a preferred embodiment dents in a sheet metal structure are removed by a single impulse whereby the length of the interval is in the range of 1 to 5 milliseconds, preferably 3 milliseconds (depending on the field of application other impulse length may be appropriate). Thereby the impulse has approximately the shape of a half wave sin(ωt).

To implement the impulse the embodiment preferably comprises a flat multi-turn spiral coil which is arranged in a bottom part of a working head. In a preferred embodiment the working coil is preferably made out of electro-technically pure hard cooper in that a single strip having an in general rectangular cross-section is wound up to a flat even spiral as a helical coil around a coil axis. E.g. the ratio between the thickness of the material and its width is in the range of 1:3 to 1:20, although other ratios may be appropriate. In the working head the working coil is normally arranged such that in working position best performance is achieved. In general the working coil has a lateral diameter (dimension of the coil perpendicular to the coil axis) which is larger than its thickness (dimension of the coil in the direction of the coil axis). In the working head the coil is arranged such that the coil axis is in general perpendicular to the surface of the sheet metal structure to be repaired such that one side of the working coil is arranged in general parallel to the surface of the sheet metal structure. In case of strongly non flat sheet metal objects or sheet metal objects, which are damaged in the area of an edge or a bend, the side surface of the working coil may be non-flat.

In a first embodiment of a working coil has the following setup: Conductive material thickness 0.1 mm to 1 mm, made out of cooper or aluminium or a similar conductive material; insulating layer thickness 1 μm to 130 μm made out of Kapton, polyester or an other appropriate insulating material; reinforcement layer thickness 0.1 mm to 1 mm, made out of carbon fibre composite or another appropriate material. The height of the working coil in total is in the range of 5 mm to 20 mm and the overall diameter of the working coil is in the range of 40 mm to 100 mm. The reinforcement layer may not present along the total length of the coil.

In a second embodiment of a working coil comprises per layer one layer of conductive material, one layer of insulating material and one layer of reinforcement material. In a third embodiment of a working coil the coil comprises per layer one layer of conductive material, a first layer of insulating material and one layer of reinforcement material and a second layer of insulating material. In a forth embodiment of a working coil the coil comprises per layer one layer of conductive material, a first layer of reinforcement material, one layer of insulating material and a second layer of reinforcement material.

In a fifth embodiment of a working coil the working coil has the following setup: The coil is made out of a conductive strip made out of wolfram material. To simplify bending of the material the coil consists out of at least two strips of wolfram, each e.g. having a thickness of 0.25 mm, are laid on top of each other and wound up to a flat helical coil. The wolfram strips are interconnected to each other at both ends by welding, e.g. with titan. The strips of material are wound onto an in general cylindrical core e.g. made out of cooper or brass. The core acts as contacting means for the inner end of the coil. Therefore the coil is electrically interconnected to the core e.g. by welding with titan. Other setups may be appropriate depending on the field of application.

To control the mechanical reaction forces occurring in each working cycle, the windings of the coil are in a preferred embodiment carried of by the design of coil. Thereby the cross section of the windings of the working coil are chosen such that the coil stabilizes itself, e.g. in that the strip forming the coil comprises a cross-section which interlocks due to windup of the coil or is arranged at an angle with respect to the centre axis of the coil such that vertical forces (parallel to the axis of the coil) are transferred in lateral forces.

The single windings of the coil are isolated by an appropriate insulation material. Good results have been achieved by a material known as Kapton. Alternatively or in addition the windings may be plated or covered by an insulation material. Due to the excessive radial forces, which occur in the material directly or indirectly due to the magnetic field the windings of the coil are mechanically stabilized. Good results have been achieved by a layer or a sequence of layers of reinforcement material which is arranged between two windings of the coil and/or insulation material. The reinforcement material preferably comprises fibres, such as high modulus carbon fibres composite, whereby the fibres are in general aligned in longitudinal direction to the coil winding.

In difference to the prior art the axis of the coil and the axis of the dent are in working position in general aligned to each other. The mechanical forces acting onto the sheet material to be repaired can be described as follows

Fₘ≈(Bₐᵥgrad(B)/μ₀)·((μᵣ−1)/μᵣ)·A·tₕ (equation 3)

and the mechanical pressure

Pₘ=Fₘ/A≈(Bₐᵥgrad(B)/μ₀)·((μᵣ−1)/μᵣ)·tₕ (equation 4)

whereby the Bₐᵥ corresponds to the average value of the magnetic induction in the cross section of the sheet metal to be repaired, grad(B) corresponds to the gradient of magnetic induction in the cross section of the sheet to be repaired, μ₀ is the permeability in vacuum (air), μᵣ is the relative sheet metal permeability, A corresponds to an area on the surface of the sheet metal to be repaired middle of the dent and tₕ is the thickness of the sheet metal.

In a typical working cycle according to the present invention the impulse in the working coil of the working tool forms in an axis of a dent an average value of magnetic induction of Bₐᵥ of approximately 10 to 15 Tesla. Due to this the relative permeability μ, in a ferromagnetic sheet metal structure decreases approximately to a value of μᵣ≈1.2. In spite of such a relatively low value of relative permeability μᵣ a mechanical pressure occurs which interacts with the surface of the dent which is sufficiently capable in removing the dent.

The herein described device is preferably suitable for removing dents with a diameter of approximately 1 to 10 cm in a sheet metal structure with a thickness of approximately 0.5 to 1.5 mm as they normally are caused by hail or park damage.

The working head is in general placed directly or indirectly above the dent onto the sheet metal structure to be repaired. Due to the dynamic of the process the working head may have a tendency to leave an impression in the surface of the sheet metal structure if placed wrong. This problem has been overcome by special adapter means which support the working head and distribute the occurring forces evenly such that the sheet metal structure remains intact and best results are achieved. The adapter means further space the working head apart from the sheet metal structure adjusting the intensity and distribution of the magnetic forces applied. The adapter means may be integrated into the working head or formed out as a separate part.

In a preferred embodiment adapter means comprise a relatively thin section of material which evenly distributes the occurring forces. Depending on the field of application, good results have been achieved by at least one layer of a non-magnetic active material such as Nylon, Teflon or relatively rigid rubber, whereby the adapter means comprise on the side exposed to the dent a cavity or an opening extending throughout the layer. The cavity or the opening is preferably having an in general conical shape extending in the direction of the dent. The recess or opening is in general adjusted to the size and form of the dent and smoothly blends into the surrounding surface. It becomes possible that the dent is dynamically pulled into the cavity or the opening of the adapter means, above the level of the final surface such that it springs back to the achieved position or subsequently may be pressed back manually. The thickness of the adapter means is determined in view of the size and the form of the dent and the sheet metal. If appropriate the adapter means may comprise more than a layer, e.g. one layer made out of a relatively rigid material and a second layer made out of a relatively soft material. In general the adapter means are having a thickness in the range of 1 to 10 mm whereby the diameter of the recess, respectively the opening is in the range of 10 to 100 mm. Depending on the field of application other sizes and dimensions may be appropriate. The adapter means may consist of more than one part adjusted to the surface to be repaired. E.g. with curved sheet metal structures, where the adapter means are forming an interface between the working head and the damaged surface, the adapter means comprise a first part adapted to the contour to be repaired and a second part adapted to the working head whereby the first and the second part are interconnected by an interface. For repairing damaged surfaces of cars adapter means may be provided for each car separately or in a kit such that they may be assembled according to individual needs.

A few advantages of the herein disclosed invention can be summarized as follows:
A system according to the present is based in general on a one-step cycle type. This provides relatively simple and cost efficient solution of electronic circuits of the charging device.
The axis of symmetry of the dent removal forces is in general aligned with the axis of the working coil. This enables the design of a working tool with a relatively small dimension.
The working coil can be designed such that it is applicable onto curved, respectively non-flat surface.
The attracting forces are not influenced by the electrical conductivity of the material to be repaired.
The source of the energy for the impulse may be a capacitor bank which is driven by a relatively low voltage and cheap and widely available connecting cables between the tool head and the power unit. In a preferred embodiment the power supply is 230 V 50 Hz 16 A.

The dent removal device may comprise a central processing unit (CPU) which is interconnected to a multifunction display and an actuator (e.g. touch screen display, knobs). A database, e.g. with information about cars, airplanes and sheet metals used with these devices, may be saved in a memory means which is interconnected to the CPU, such that it becomes possible to retrieve specific information about or to calculate best working parameters. The working parameters may then be used in the dent removal device during the dent removal process to achieve optimum results without extensive testing or adjusting. The CPU may be foreseen to fulfill additional functions such as counting working cycles, time used in total or spent per sheet metal structure, job history. This information may specifically be used to determine maintenance cycles and for calculating cost. If appropriate this information may be transmitted remotely by an appropriate device e.g. such as a GSM-Module.

In an embodiment of the invention the device for removing a dent in a sheet metal structure made out of a ferromagnetic material comprises a reservoir means, which is charged by a charging means, a working head with a working coil interconnected via a switching means to the reservoir means and an adapter means suitable to temporarily interconnect the working head with a sheet metal structure during a dent removing process.

The working coil may comprise a strip made out of a conductive material wound up around a coil axis whereby the single turns of the coil are separated by at least one insulating layer and if appropriate at least one reinforcement layer. The reinforcement layer may comprise composite material with reinforcement fibres. To improve lateral strength the fibres are in general arranged in the direction of the strip. The working coil may comprise at least one channel for conducting a cooling fluid to the working coil. The adapter means may comprise at least one cavity exposed during operation in the direction of the dent to be removed such that the sheet metal structure to be repaired may be pulled into the cavity. The cavity may have an in general conical shape. The cavity may extend throughout the adapter means forming an opening. The adapter means may be built out as a separate part.

A process according to the present invention for removing a dent in a sheet metal structure made out of ferromagnetic material, comprises in general the following process steps: a) Charging reservoir means by charging means; b) Arranging a working head with a working coil, on the concave side of a dent of a sheet metal structure to be repaired; c) Conducting at least a part of the electrical energy stored in the reservoir means into the working coil, such that a magnetic field is actuated in the working coil implementing a mechanical force into the sheet metal structure such that the depth of the dent is at least partially reduced; d) If necessary repeating the steps. If appropriate an adapter means is placed between the working head and the sheet metal structure to be repaired. The adapter means may comprise a cavity exposed to the dent to be removed such that the sheet metal in the area is dynamically pulled into the cavity of the adapter means. The cavity may extend across the adapter means. The adapter means may project laterally over the working head. The adapter means may evenly distribute reaction forces into the sheet metal structure.

### BRIEF DESCRIPTION OF THE DRAWINGS

The terms and expressions which have been employed are used as terms of description and not of limitation, and there is no intention of excluding any equivalents of the features shown and described or portions thereof in the use of such terms and expressions, but it is recognized that various modifications are possible within the scope of the invention claimed.

For a more complete understanding of the present invention, including its features and advantages, reference is now made to the detailed description of the invention, taken in conjunction with the accompanying drawings, in which:

FIG. 1 shows a first embodiment of a working head in a cut open view in perspective manner;

FIG. 2 shows a cross-cut through a first embodiment of a working coil;

FIG. 3 shows a cross-cut through a second embodiment of a working coil;

FIG. 4 shows a cross-cut through a second embodiment of a working head;

FIG. 5 shows an application of a dent removing device according to the present invention;

FIG. 6 shows a working head in a perspective view arranged above a dent;

FIG. 7 shows the working head in a side view;

FIG. 8 shows schematically the setup of a power unit.

### DETAILED DESCRIPTION OF DRAWINGS

Reference is now made in detail to embodiments of the invention, examples of which are illustrated in the accompanying drawings.

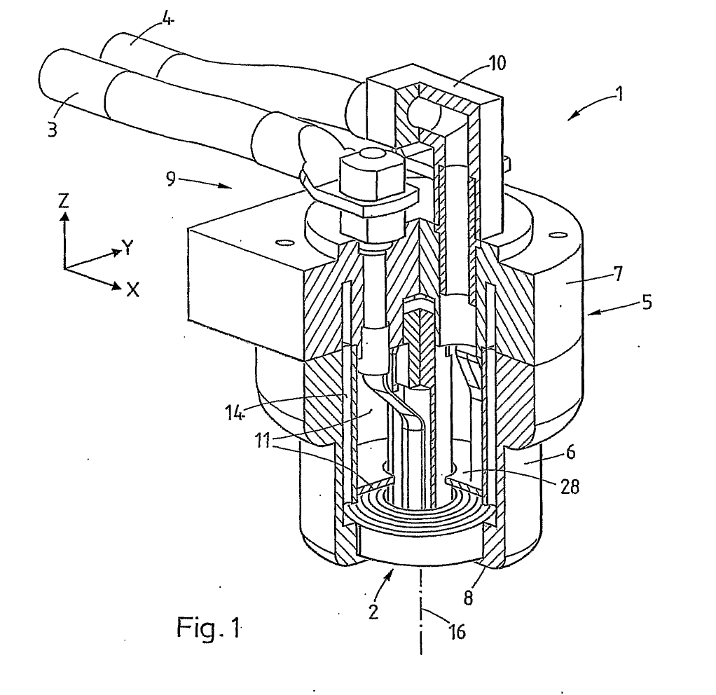

FIG. 1 shows a first embodiment of a lower part of a working head 1 of a dent removing device according to the present invention in a perspective partially cut open view. The working head 1 comprises a working coil 2 and a first and a second electrical connector 3, 4, which are interconnected to the working coil 2. The working head 1 further comprises a housing 5 which comprises a side wall 6, a top portion 7 and a bottom portion 8. The top portion 7 comprises a third and a fourth connector 9, 10 for in- and outlet of a cooling fluid (not shown in detail) into a cavity 11 arranged above the working coil 2 suitable to receive cooling fluid. As it can be seen the working coil 2 is arranged close to the bottom portion 8 of the housing 5 whereby the axis of the working coil is arranged in general perpendicular to the bottom portion 8, respectively parallel to the side wall 6.

In the shown embodiment the lower part of the working head comprises channels 14 interconnected to the inlet 9 of the cooling fluid. The channels 14 are here integrated in the side wall 6 and inject the cooling fluid into the cavity 11 onto the working coil 2 such that sufficient cooling is ensured. A diaphragm 28 supports the turbulences in the cooling fluid for better transfer of the heat. Depending on the field of application the working coil 2 may comprise at least one opening for the cooling fluid to pass. The at least one opening is arranged such that no negative influence takes place with respect to the magnetic field.

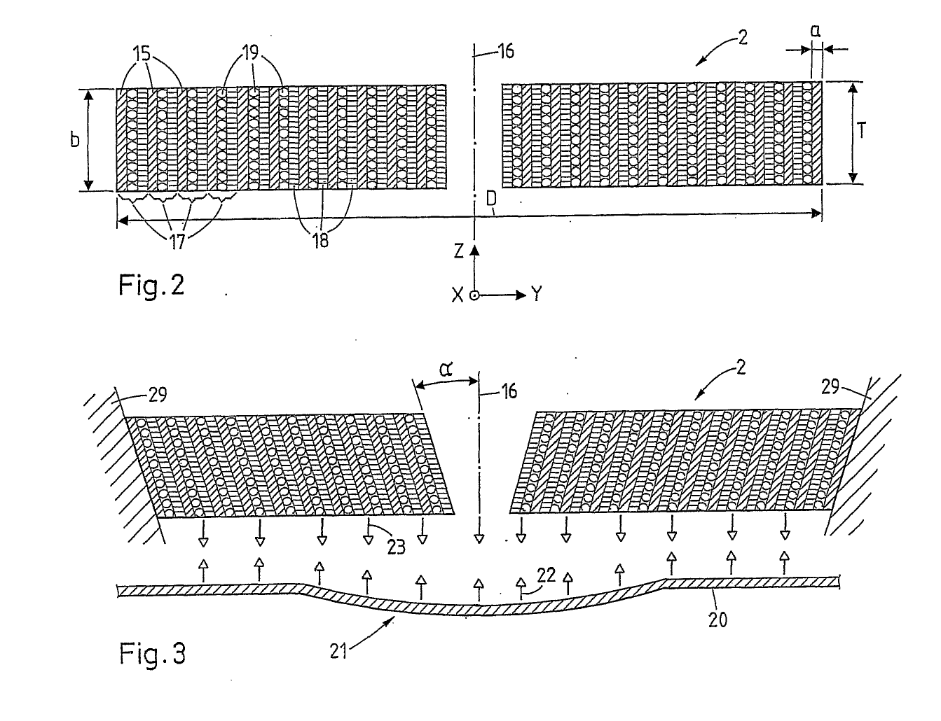

FIG. 2 shows a cross-cut through a flat, single coiled working coil 2 in side view. As it can be seen the diameter D of the working coil 2 is in the shown embodiment significantly larger than the thickness T. The ratio between D and T is approximately in the range of 4:1 to 8:1. However, depending on the field of application, other ratios may be applicable. The working 2 coil consists out of a single strip 15 of conductive material which is wound up around a coil axis 16. The strip 15 has a rectangular cross-section whereby the width b in general corresponds to the thickness T of the working coil 2. The thickness a of the strip 15 thereby amounts to about 0.1 to 1 of the width b. The single coil windings 17 of the strip 15 are separated by at least one insulating layer 18 and at least one reinforcement layer 19. The insulating layer 18 insulates the single coil-windings with respect to their neighbouring coil-windings and the reinforcement layer 19. The insulating layer 18 and the reinforcement layer 19 are wound up together with the strip 15 and joined to the strip by an appropriate adhesive. The reinforcement layer 19 primarily stabilizes the working coil 2 in radial direction. Alternatively or in addition to the internal reinforcement material the stability of the coil may be increased by an outer ring of reinforcement material.

FIG. 3 shows a cross section through a further embodiment of a working coil 2. The working coil 2 is arranged at a certain distance z1 to a sheet metal structure 20 with a dent 21. Action and reaction forces which may occur during carrying out of the method are schematically indicated by arrows 22, 23. The single coil windings 17 (electrically conductive strip, insulating layer and if appropriate reinforcement layer) of this coil 2 are arranged inclined at an angle α with respect to the coil axis 16. The outside of the working coil 2 is supported by abutments 29 which are during the process directly or indirectly mechanically interconnected with the sheet metal structure 20 to be repaired. The advantage of the shown embodiment is that vertical reaction forces 23 are transferred in lateral forces carried off by the abutments 29 resulting in a reduced risk that the windings 17 of the coil 2 are damaged due to extensive shear forces.

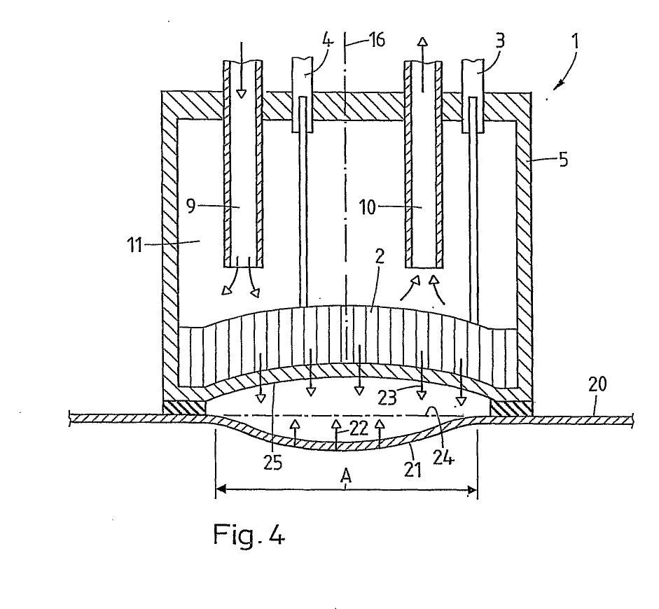

FIG. 4 is showing a further embodiment of a working head 1 in a cross-cut view. On the top of the housing 5 two electrical connectors 3, 4 are arranged which serve to interconnect the working coil 2 with a power supply (not shown in detail). The housing further comprises an inlet 9 and an outlet 10 for a non-conducting cooling fluid into the cavity 11 which is arranged above the working coil 2 such that the fluid directly or indirectly cools the working coil 2. As it can be seen the working coil 2 has a curved cross-section with a concave shape in the direction of the dent 21. This offers the possibility to pull the sheet metal structure 20 in the area of dent 21 in a controlled manner above the achieved surface level 24. The concave shape 25 of the bottom part 8 of the housing 5 may thereby act as a stop.

Due to specifically adopted shapes of the bottom part 8 and the coil 2 it is possible to apply the herein discussed invention on non-flat sheet metal structures.

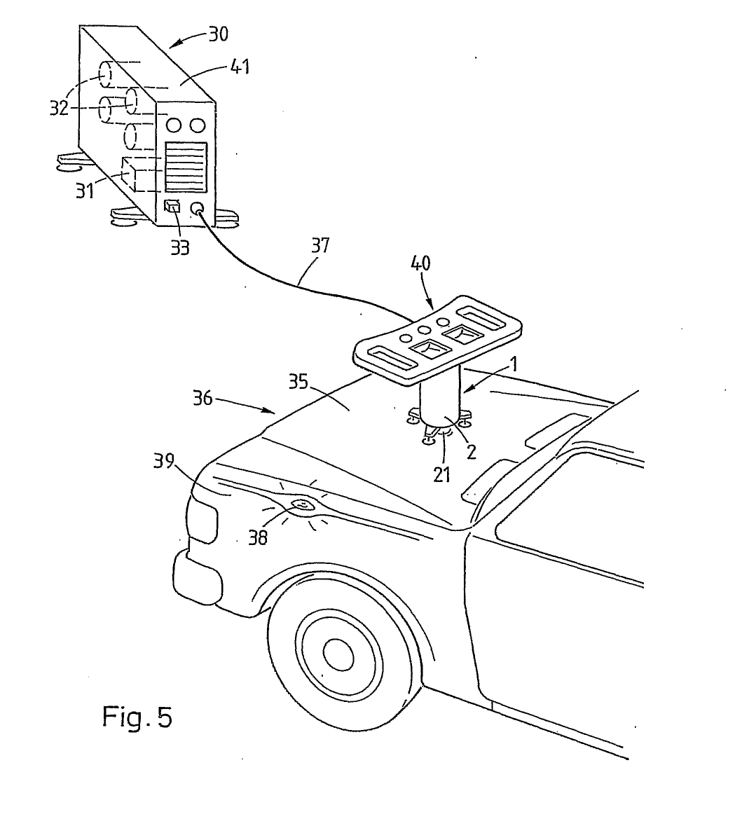

FIG. 5 shows a dent removing device according to the herein presented invention in action.

In a first step an array of capacitors 32, which are here arranged within a housing 29 of a power device 30, are filed up with electrical energy by the charging device 31. The working coil 2, respectively the working head 1, are arranged on the concave side of a dent 21 of a panel 35 of a car 36 to be repaired. After proper positioning of the working head 1 above the dent 21 at least a part of the electrical energy stored in the power device 30 is released in a controlled manner via a connecting cable 37 into the working coil 2 by switching a thyristor 33 conductive. Thereby a magnetic field is actuated in the working coil 2 implementing a mechanical force for reducing the depth of the dent 21 at least partially or completely. If necessary the steps of the process are repeated. An advantage of the herein discussed invention is that even dents 38 in non-flat sheet metal structures, such as a fender 39 may easily be repaired. The process is triggered and controlled by control means 40.

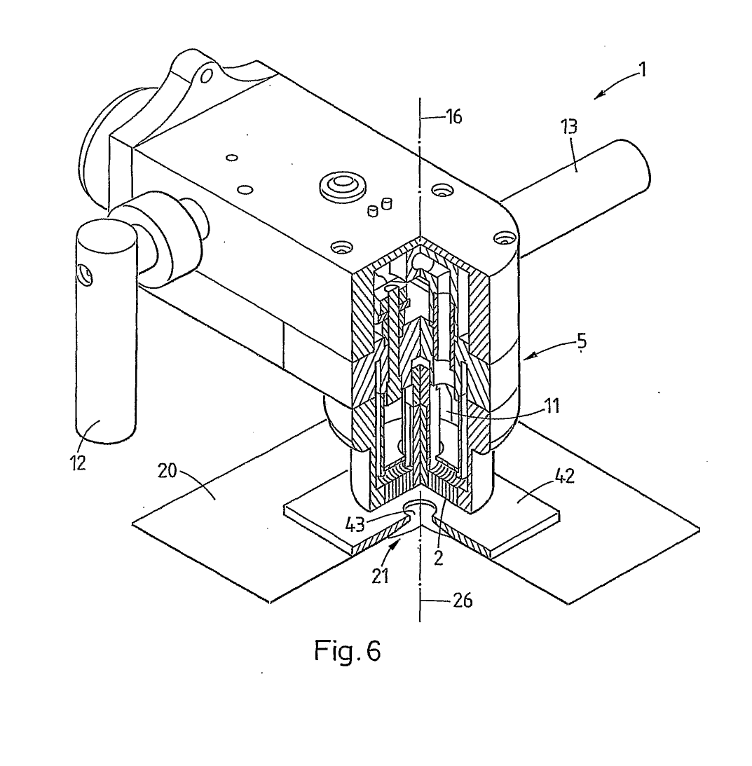

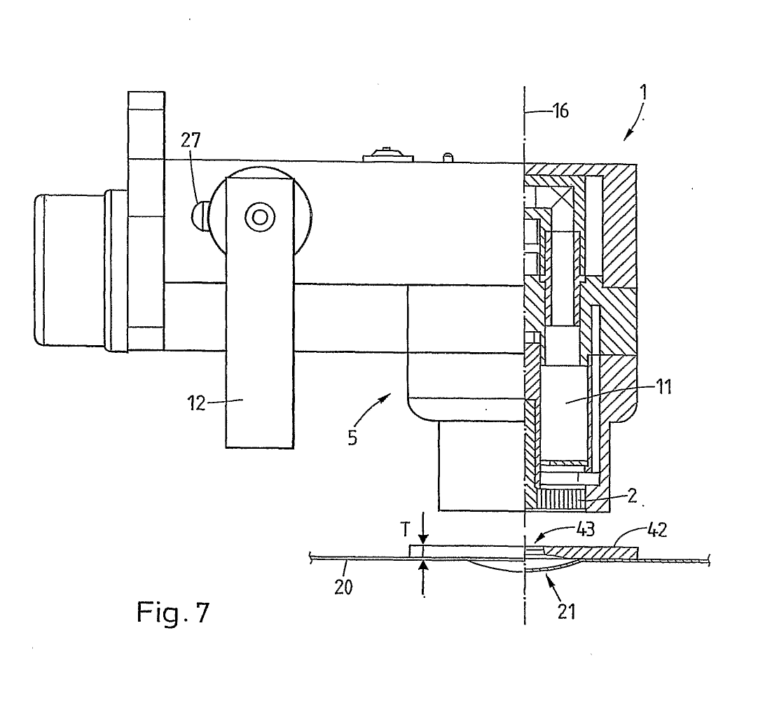

FIG. 6 is showing a preferred embodiment of a working head 1 in a perspective view above a sheet metal structure 20 having a dent 21. The working head 1 is displayed partially cut such that it is possible to look at the inside. FIG. 7 is showing the working head 1 according to FIG. 6 in a side view. The working head is also partially cut such that it is possible to see part of the working coil 2 and the cavity 11 arranged above the working coil 2. The working head 1 comprises a housing 5 with a left and a right handle 12, 13 to securely and precisely position the working coil 2 with respect to the dent 21. Good results are achieved when the axis 16 of the working coil 2 is in general aligned symmetrically with a dent axis 24 of the dent 21. The handles 12, 13 may comprise switches 27 to trigger and control the process. If appropriate the device 1 is equipped with an optical targeting aid (not shown in detail), e.g. a fibre optic, which helps to position the working coil 2 with respect to the dent 21. The targeting aid may be interconnected to an optical display system (not shown in detail) incorporated in the working head 1. If appropriate the device comprises a tripod to securely place the working head 1 on the sheet metal structure 20 to be handled. Between the working head 1 and the dent 21 an adapter means 42 is arranged which supports the working head 1 and distribute the occurring forces evenly such that the surrounding sheet metal structure 20 remains intact and best results are achieved. The adapter means 42 spaces the working head 1 apart from the sheet metal structure 20 adjusting the intensity and distribution of the magnetic forces applied. In the shown embodiment the adapter means are built out as a separate device but may be, if appropriate, integrated into the working head 1.

In the shown embodiment the adapter means 42 consists out of a relatively thin section of material which evenly distributes the occurring loads. The adapter means 42 comprises an opening 43 extending throughout the adapter means 42. The opening 43 is having an in general conical shape whereby the larger diameter is directed to the dent 21. The opening 43 is adjusted to the size of the dent 21 and smoothly blends into the surrounding surface. During a dent removing process the cavity 43 allows that the sheet metal structure 20 in the area of the dent 21 is dynamically pulled above the level of the surrounding surface of the sheet metal structure 20. The cavity 43 forms a natural stop which avoids that the sheet metal is pulled too far. Therefore it becomes obvious that the shape and the form of the cavity 43 have certain significance with respect to the end result achieved. In the shown embodiment the cavity 43 extends across the thickness of the adapter means 42 forming an opening such that during the dent removing process the air may escape. By forming the cavity 43, e.g. not-throughout, it is possible that during the dent removing process an air cushion remains between the sheet metal structure and the adapter means, such that the sheet metal attracted by the working head 1 is elastically retarded.

The thickness T of the adapter means 42 is determined in view of the size and the form of the dent 21 and the sheet metal 20. If appropriate the adapter means 42 may comprise more than one layer, e.g. one layer made out of a relatively rigid material and a second layer made out of a relatively soft material. The adapter means 42 are normally attached temporarily to the surface to be repaired, e.g. by sticking plaster. If appropriate the adapter means 42 may comprise at least partially magnetic material such that the adapter means 42 stick to the surface of a ferromagnetic material on their own. In a preferred embodiment the adapter means are built out as a targeting aid such that the precision of the dent removal process is increased.

In FIGS. 6 and 7 the working head 1 is, for better visibility and understanding, arranged at a certain distance above the adapter means 42. However, during the dent removing process the working head 1 is normally in contact with the adapter means 42 such that the occurring reaction forces are evenly distributed.

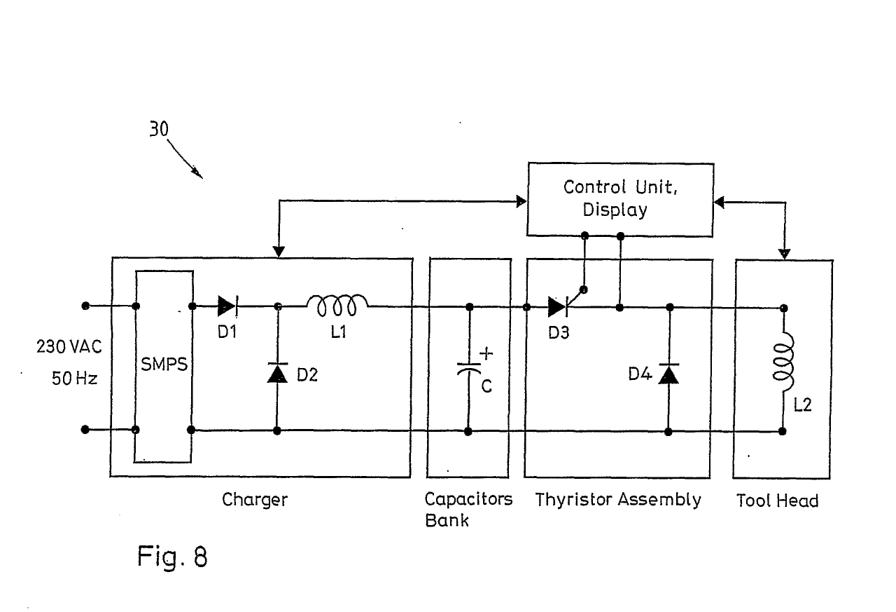

FIG. 8 schematically shows a set up of a power device 30 according to the present invention. The power device briefly comprises a switching power supply unit by which electric power from a power socket is transformed into an appropriate form to be stored in a capacitor bank interconnected to the switching power supply. The release of the electrical energy stored in the capacitor bank is controlled by a thyristor assembly which acts as a gating device and which is interconnected to the capacitor bank and a working head of the dent removing device. If appropriate the thyristor assembly, the switching power supply, the capacitor bank and the tool head are controlled and triggered directly or indirectly by a control unit.

1. A device for removing a dent in a sheet metal structure made out of a ferromagnetic material comprising a reservoir charged by a charging device, a working head with a working coil interconnected via a switching device to the reservoir means and an adapter configured to temporarily interconnect the working head with a sheet metal structure during a dent removing process.

2. The device according to claim 1, wherein the working coil comprises a strip made out of a conductive material wound up around a coil axis whereby single turns of the coil are separated by at least one insulating layer and at least one reinforcement layer.

3. The device according to claim 2, wherein the reinforcement layer comprises composite material with reinforcement fibres.

4. The device according to claim 3, wherein the fibres are arranged substantially in the direction of the strip.

5. The device according to claim 1, wherein the working coil further comprises at least one channel for conducting a cooling fluid to the working coil.

6. The device according to claim 1, wherein the adapter comprises at least one cavity exposed during operation in the direction of the dent to be removed such that the sheet metal structure to be repaired is pulled into the cavity.

7. The device according to claim 6, wherein the cavity has a substantially conical shape.

8. The device according to claim 6, wherein the cavity extends throughout the adapter to form an opening therein.

9. The device according to claim 1, wherein the adapter is constructed as a separate part.

10. A process for removing a dent in a sheet metal structure made out of ferromagnetic material, comprising:
a) Charging a reservoir using a charging device;
b) Arranging a working head with a working coil, on a concave side of the dent to be repaired;
c) Conducting at least a part of the electrical energy stored in the reservoir into the working coil, such that a magnetic field is actuated in the working coil implementing a mechanical force into the sheet metal structure such that a depth of the dent is at least partially reduced.

11. The process according to claim 10, wherein an adapter is placed between the working head and the sheet metal structure to be repaired.

12. The process according to claim 11, wherein the adapter comprises a cavity exposed to the dent to be removed such that the sheet metal in the area is dynamically pulled into the cavity of the adapter.

13. The process according to claim 12, wherein the cavity extends across the adapter.

14. The process according to claim 11, wherein the adapter laterally projects over the working head.

15. The process according to claim 11, wherein the adapter evenly distributes reaction forces into the sheet metal structure.

16. The process of claim 10, further comprising repeating the steps of charging, arranging, and conducting when desired.
